(19) United States
(12) Patent Application Publication
(10) Pub. No.: US 2020/0379478 A1
(43) Pub. Date: Dec. 3, 2020

(54) MOVING ROBOT AND CONTROL METHOD THEREOF

(71) Applicants: LG ELECTRONICS INC., Seoul (KR); SEOUL NATIONAL UNIVERSITY R&DB FOUNDATION, Seoul (KR)

(72) Inventors: Yongmin SHIN, Seoul (KR); Donghoon YI, Seoul (KR); Ilsoo CHO, Seoul (KR); Dongil CHO, Seoul (KR); Taejae LEE, Gyeonggi-do (KR)

(21) Appl. No.: 16/604,769

(22) PCT Filed: Apr. 11, 2018
(86) PCT No.: PCT/KR2018/004227

§ 371 Date: Oct. 11, 2019

(30) Foreign Application Priority Data
Apr. 28, 2017 (KR) 10-2017-0055694

(51) Int. Cl. G05D 1/02; A47L 9/28

(52) U.S. Cl. CPC G05D 1/0251; G05D 1/0238; G05D 2201/0215; A47L 2201/04; A47L 9/28

(57) ABSTRACT

A cleaner includes a main body having a suction opening, a cleaning unit provided within the main body and sucking a cleaning target through the suction opening, a driving unit moving the main body, an operation sensor detecting information related to movement of the main body, a camera capturing a plurality of images according to movement of the main body, and a controller detecting information related to a position of the main body on the basis of at least one of the captured images and information related to the movement.

### TECHNICAL FIELD

The present disclosure relates to a robot which performs autonomous traveling and a control method thereof, and more particularly, to a robot which performs a cleaning function during autonomous traveling and a control method thereof.

### BACKGROUND ART

In general, a robot has been developed for an industrial purpose and has been in charge of part of factory automation. Recently, robot-applied fields have further extended to develop medical robots or aerospace robots, and home robots that may be used in general houses have also been made.

A typical example of home robots is a robot cleaner, which is a sort of a home appliance for performing cleaning by sucking ambient dust or foreign objects, while traveling in a predetermined area. Such a robot cleaner includes a generally rechargeable battery and has an obstacle sensor capable of avoiding an obstacle during traveling so that the robot cleaner may perform cleaning, while traveling.

Recently, beyond performing cleaning while robot cleaners are simply autonomously traveling in a cleaning area, research into utilization of robot cleaners in various fields such as healthcare, smart home, remote control, and the like, has been actively conducted.

### DISCLOSURE OF INVENTION

### Technical Problem

Therefore, an aspect of the detailed description is to provide a cleaner capable of detecting information related to an obstacle by using a monocular camera or only a single camera, and a control method thereof.

Another aspect of the detailed description is to provide a cleaner which performs autonomous traveling and which is capable of detecting an obstacle present in all directions in relation to a body of a robot using only a single camera, and a control method thereof.

### Solution to Problem

To achieve these and other advantages and in accordance with the purpose of this specification, as embodied and broadly described herein, a cleaner includes: a main body having a suction opening; a cleaning unit provided within the main body and sucking a cleaning target through the suction opening; a driving unit moving the main body; an operation sensor detecting information related to movement of the main body; a camera capturing a plurality of images according to movement of the main body; and a controller detecting information related to a position of the main body on the basis of at least one of the captured images and information related to the movement.

In an embodiment, the controller may detect feature points corresponding to predetermined subject points present in a cleaning area with respect to the plurality of captured images, and detect information related to the position of the main body on the basis of the detected common feature points.

In an embodiment, the controller may calculate a distance between the subject points and the main body on the basis of the detected common feature points.

In an embodiment, while the plurality of images are being captured, the controller may correct the detected information related to the position of the main body on the basis of information detected by the operation sensor, while the plurality of images are being captured.

In an embodiment, when the camera images a ceiling of the cleaning area, the controller may detect feature points corresponding to a corner of the ceiling from the plurality of images.

In an embodiment, when a preset time interval has lapsed since a first image was captured, the camera may capture a second image.

In an embodiment, after the first image is captured, when the main body moves by a predetermined distance or rotates by a predetermined angle, the camera may capture the second image.

In an embodiment, the camera may be installed at one point of the main body such that a direction in which a lens of the camera is oriented is fixed.

In an embodiment, an angle of coverage of the camera may correspond to all directions with respect to the main body.

In an embodiment, the controller may newly generate a third image by projecting the first image among the plurality of images to the second image among the plurality of images, and detect information related to an obstacle on the basis of the generated third image.

According to the present invention, since an obstacle may be detected with only one camera, manufacturing cost of the robot cleaner may be reduced.

In addition, the robot cleaner according to the present invention may improve performance of obstacle detection using a monocular camera.

In addition, the robot cleaner according to the present invention may accurately detect an obstacle without being affected by an installation state of the camera.

Further scope of applicability of the present application will become more apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from the detailed description.

### BRIEF DESCRIPTION OF DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram illustrating a configuration of a moving robot according to an embodiment of the present invention.

FIG. 1B is a block diagram illustrating a detailed configuration of a sensor of a moving robot according to an exemplary embodiment of the present invention.

FIG. 2 is a conceptual diagram illustrating the appearance of a moving robot according to an embodiment of the present invention.

FIG. 3 is a flowchart illustrating a method of controlling a moving robot according to an embodiment of the present invention.

FIGS. 4A and 4B are conceptual diagrams illustrating an angle of view of a camera sensor of a moving robot according to the present invention.

FIG. 5 is a conceptual diagram illustrating an embodiment in which a moving robot extracts a feature line from a captured image.

FIG. 6 is a conceptual diagram illustrating an embodiment in which a moving robot according to the present invention detects a common subject point corresponding to a predetermined subject point present in a cleaning area from a plurality of captured images.

FIG. 7 is a conceptual diagram illustrating an embodiment in which a moving robot according to the present invention detects an obstacle by dividing a captured image.

FIGS. 8A to 8F are conceptual diagrams illustrating an embodiment in which a moving robot according to the present invention detects an obstacle using a captured image.

FIG. 9 is a flowchart illustrating a method of controlling a moving robot according to another embodiment of the present invention.

### BEST MODE FOR CARRYING OUT THE INVENTION

Hereinafter, embodiments of the present disclosure will be described in detail with reference to the accompanying drawings. The technical terms used in the present specification are set forth to mention specific embodiments of the present invention, and do not intend to define the scope of the present invention. As far as not being defined differently, all terms used herein including technical or scientific terms may have the same meaning as those generally understood by an ordinary person skilled in the art to which the present disclosure pertains and should not be construed in an excessively comprehensive meaning or an excessively restricted meaning.

Technical terms used in this specification are used to merely illustrate specific embodiments, and should be understood that they are not intended to limit the present disclosure. As far as not being defined differently, all terms used herein including technical or scientific terms may have the same meaning as those generally understood by an ordinary person skilled in the art to which the present disclosure belongs to, and should not be construed in an excessively comprehensive meaning or an excessively restricted meaning.

In addition, if a technical term used in the description of the present disclosure is an erroneous term that fails to clearly express the idea of the present disclosure, it should be replaced by a technical term that may be properly understood by the skilled person in the art. In addition, general terms used in the description of the present disclosure should be construed according to definitions in dictionaries or according to its front or rear context, and should not be construed to have an excessively restrained meaning.

In the following description, usage of suffixes such as ‘module’, ‘part’ or ‘unit’ used for referring to elements is given merely to facilitate explanation of the present invention, without having any significant meaning by itself.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

The exemplary embodiments of the present invention will now be described with reference to the accompanying drawings, in which like numbers refer to like elements throughout.

Also, in describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

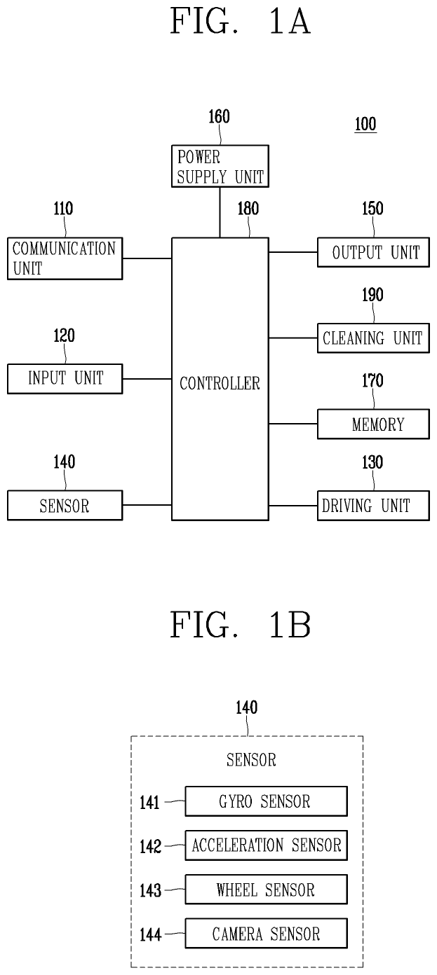

FIG. 1A illustrates a configuration of a moving robot according to an embodiment of the present disclosure.

As illustrated in FIG. 1A, the moving robot according to an embodiment of the present disclosure may include at least one of a communication unit 110, an input unit 120, a driving unit 130, a sensing unit 140, an output unit 150, a power supply unit 160, a memory 170, a controller 180, and a cleaning unit 190, and any combination thereof.

Here, the components illustrated in FIG. 1A are not essential and a robot cleaner including greater or fewer components may be implemented. Hereinafter, the components will be described.

First, the power supply unit 160 includes a battery that may be charged by external commercial power and supplies power to the inside of the moving robot. The power supply unit 160 may supply driving power to each of the components included in the moving robot to provide operation power required for the moving robot to travel (or move or run) or perform a specific function.

Here, the controller 180 may detect a remaining capacity of power of the battery, and when the remaining capacity of power is insufficient, the controller 180 controls the moving robot to move to a charging station connected to an external commercial power so that the battery may be charged upon receiving a charge current from the charging station. The battery may be connected to a battery sensing unit and a remaining battery capacity and a charging state thereof may be transmitted to the controller 180. The output unit 150 may display a remaining battery capacity on a screen by the controller 180.

The battery may be positioned on a lower side of the center of the robot cleaner or may be positioned on one of left and right sides. In the latter case, the moving robot may further include a balance weight (or a counter weight) in order to resolve weight unbalance of the battery.

Meanwhile, the driving unit 130 may include a motor and drive the motor to rotate left and right main wheels of the main body of the moving robot in both directions to rotate or move the main body. The driving unit 130 may move the main body of the moving robot forwards/backwards and leftwards/rightwards, or enable the main body of the moving robot to travel in a curved manner or rotate in place.

Meanwhile, the input unit 120 receives various control commands regarding the robot cleaner from a user. The input unit 120 may include one or more buttons, for example, an OK button, a setting button, and the like. The OK button is a button for receiving a command for checking detection information, obstacle information, position information, and map information from the user, and the setting button may be a button for receiving a command for setting the aforementioned types of information from the user.

Also, the input unit 120 may include an input resetting button for canceling a previous user input and receiving a user input again, a delete button for deleting a preset user input, a button for setting or changing an operation mode, or a button for receiving a command for returning to the charging station.

Also, the input unit 120 may be installed in an upper portion of the moving robot, as a hard key, a soft key, or a touch pad. Also, the input unit 120 may have a form of a touch screen together with the output unit 150.

Meanwhile, the output unit 150 may be installed in an upper portion of the moving robot. An installation position or an installation form thereof may be varied. For example, the output unit 150 may display a battery state or a traveling scheme.

Also, the output unit 150 may output information regarding a state of an interior of the moving robot detected by the sensing unit 140, for example, a current state of each component included in the moving robot. Also, the output unit 150 may display external state information, obstacle information, position information, and map information detected by the sensing unit 140 on a screen. The output unit 150 may be configured as at least one device among a light emitting diode (LED), a liquid crystal display (LCD), a plasma display panel (PDP), an organic light emitting diode (OLED).

The output unit 150 may further include a sound output unit audibly outputting an operational process or an operation result of the moving robot performed by the controller 180. For example, the output unit 150 may output a warning sound outwardly according to a warning signal generated by the controller 180.

Here, the sound output unit may be a unit for outputting a sound, such as a beeper, a speaker, and the like, and the output unit 150 may output audio data or message data having a predetermined pattern stored in the memory 170 through the sound output unit.

Thus, the moving robot according to an embodiment of the present disclosure may output environment information regarding a traveling region on a screen or output it as a sound through the output unit 150. Also, according to another embodiment, the moving robot may transmit map information or environment information to a terminal device through the communication unit 110 such that the terminal device may output a screen or a sound to be output through the output unit 150.

Meanwhile, the communication unit 110 may be connected to the terminal device and/or a different device positioned within a specific region (which will be used together with a “home appliance” in this disclosure) according to one communication scheme among wired, wireless, and satellite communication schemes to transmit and receive data.

The communication unit 110 may transmit and receive data to and from a different device positioned within a specific region. Here, the different device may be any device as long as it may be connected to a network and transmit and receive data. For example, the different device may be a device such as an air-conditioner, a heating device, an air purifier, a lamp, a TV, an automobile, and the like. Also, the different device may be a device for controlling a door, a window, a plumbing valve, a gas valve, and the like. Also, the different device may be a sensor detecting a temperature, humidity, atmospheric pressure, a gas, and the like.

Accordingly, the controller 180 may transmit a control signal to the other device through the communication unit 110, so that the other device may operate according to the received control signal. For example, in case where the other device is an air-conditioner, it is possible to turn on power or perform cooling or heating for a specific area according to a control signal, and in the case of a device for controlling a window, the window may be opened or closed or may be opened at a certain rate according to a control signal.

In addition, the communication unit 110 may receive various state information from at least one other device located in a specific area. For example, the communication unit 110 may receive a set temperature of the air conditioner, whether the window is opened or closed, opening and closing information indicating a degree of opening or closing the window, a current temperature of the specific area sensed by the temperature sensor, and the like.

Accordingly, the controller 180 may generate a control signal for the other device according to the status information, a user input through the input unit 120, or a user input through a terminal device.

Here, the communication unit 110 may employ at least one communication method among a wireless communication methods such as radio frequency (RF) communication, Bluetooth, infrared data association (IrDA), wireless LAN, ZigBee, and the like, in order to communicate with at least one other device, and accordingly, the other device and the moving robot 100 may establish at least one network. Here, the network is preferably the Internet.

The communication unit 110 may receive a control signal from the terminal device. Accordingly, the controller 180 may perform a control command related to various operations according to the control signal received through the communication unit 110. For example, a control command, which may be received from the user through the input unit 120, may be received from the terminal device through the communication unit 110, and the controller 180 may perform the received control command. In addition, the communication unit 110 may transmit state information of the moving robot, obstacle information, location information, image information, map information, and the like, to the terminal device. For example, various types of information that may be output through the output unit 150 may be transmitted to the terminal device through the communication unit 110.

Here, the communication unit 110 may employ at least one communication method among wireless communication methods such as radio frequency (RF) communication, Bluetooth, IrDA, a LAN, ZigBee, and the like, to communicate with a terminal device such as a computer such as a laptop computer, a display device, and a mobile terminal (e.g., a smartphone), and accordingly, the other device and the moving robot 100 may establish at least one network. Here, the network is preferably the Internet. For example, when the terminal device is a mobile terminal, the robot cleaner 100 may communicate with the terminal device through the communication unit 110 using a communication method available to the mobile terminal.

Meanwhile, the memory 170 stores a control program controlling or driving the robot cleaner and data corresponding thereto. The memory 170 may store audio information, image information, obstacle information, position information, map information, and the like. Also, the memory 170 may store information related to a traveling pattern.

As the memory 170, a non-volatile memory is commonly used. Here, the nonvolatile memory (NVM) (or NVRAM) is a storage device capable of continuously maintaining stored information even though power is not applied thereto. For example, the memory 170 may be a ROM, a flash memory, a magnetic computer storage device (for example, a hard disk or a magnetic tape), an optical disk drive, a magnetic RAM, a PRAM, and the like.

Meanwhile, the sensing unit 140 may include at least one of an external signal sensor, a front sensor, and a cliff sensor.

The external signal sensor may sense an external signal of the moving robot. The external signal sensor may be, for example, an infrared sensor, an ultrasonic sensor, an RF sensor, and the like.

The moving robot may check a position and a direction of the charging station upon receiving a guide signal generated by the charging station using the external signal sensor. Here, the charging station may transmit the guide signal indicating a direction and a distance such that the moving robot may be returned. That is, upon receiving the signal transmitted from the charging station, the moving robot may determine a current position and set a movement direction to return to the charging station.

Also, the moving robot may detect a signal generated by a remote control device such as a remote controller or a terminal by using an external signal sensor.

The external signal sensor may be provided on one side within or outside of the moving robot. For example, the infrared sensor may be installed inside the moving robot or near the camera sensor of the output unit 150.

Meanwhile, the front sensor may be installed at a predetermined interval on a front side of the moving robot, specifically, along an outer circumferential surface of a side surface of the moving robot. The front sensor may be positioned on at least one side surface of the moving robot to sense an obstacle ahead. The front sensor may sense an object, in particular, an obstacle, present in a movement direction of the moving robot and transfer detection information to the controller 180. That is, the front sensor may sense a protrusion present in a movement path of the moving robot, furnishings, furniture, a wall surface, a wall corner, and the like, in a house, and transmit corresponding information to the controller 180.

The front sensor may be, for example, an infrared sensor, an ultrasonic sensor, an RF sensor, a geomagnetic sensor, and the like, and the moving robot may use one kind of sensor or two or more kinds of sensors together as the front sensor.

For example, in general, the ultrasonic sensor may be mainly used to sense an obstacle in a remote area. The ultrasonic sensor may include a transmission unit and a reception unit. The controller 180 may determine whether an obstacle is present according to whether an ultrasonic wave radiated through the transmission unit is reflected by an obstacle, or the like, and received by the reception unit, and calculate a distance to the obstacle by using an ultrasonic wave radiation time and an ultrasonic wave reception time.

Also, the controller 180 may detect information related to a size of an obstacle by comparing an ultrasonic wave radiated from the transmission unit and an ultrasonic wave received by the reception unit. For example, as a larger amount of ultrasonic waves is received by the reception unit, the controller 180 may determine that the size of the obstacle is larger.

In an embodiment, a plurality of ultrasonic sensors (for example, five ultrasonic sensors) may be installed on an outer circumferential surface of a front side of the moving robot. Here, preferably, the transmission units and the reception units of the ultrasonic sensors may be installed alternately on the front side of the moving robot.

That is, the transmission units may be disposed to be spaced apart from the center of the front side of the main body of the moving robot, and in this case, one or two or more transmission units may be disposed between reception units to form a reception region of an ultrasonic signal reflected from the obstacle, or the like. Due to this disposition, a reception region may be expanded, while reducing the number of sensors. A transmission angle of ultrasonic waves may be maintained at an angle of a range which does not affect other signals to prevent a crosstalk phenomenon. Also, reception sensitivity of the reception units may be set to be different.

Also, the ultrasonic sensors may be installed upwardly at a predetermined angle such that ultrasonic waves generated by the ultrasonic sensors are output upwardly, and in this case, in order to prevent the ultrasonic waves from being radiated downwardly, a predetermined blocking member may be further provided.

Meanwhile, as mentioned above, two or more kinds of sensors may be used as the front sensors, and thus, any one kind of sensors among an infrared sensor, an ultrasonic sensor, and an RF sensor may be used as the front sensors.

For example, the front sensor may include an infrared sensor as another kind of sensor, in addition to the ultrasonic sensor.

The infrared sensor may be installed on an outer circumferential surface of the moving robot together with the ultrasonic sensor. The infrared sensor may also sense an obstacle present in front of or by the side of the moving robot and transmit corresponding obstacle information to the controller 180. That is, the infrared sensor may sense a protrusion present in a movement path of the moving robot, furnishings, furniture, a wall surface, a wall corner, and the like, in a house, and transmit corresponding information to the controller 180. Thus, the moving robot may move within a cleaning area without colliding with an obstacle.

Meanwhile, as the cliff sensor, various types of optical sensors may be used, and the cliff sensor may sense an obstacle on the floor supporting the main body of the moving robot.

That is, the cliff sensor may be installed on a rear surface of the moving robot 100 and may be installed in different regions depending on a kind of a moving robot. The cliff sensor may be positioned on a rear surface of the moving robot to sense an obstacle on the floor. The cliff sensor may be an infrared sensor including a light emitting unit and a light receiving unit, an ultrasonic sensor, an RF signal, a position sensitive detector (PSD) sensor, and the like, like the obstacle sensor.

For example, any one of cliff sensors may be installed on the front side of the moving robot, and the other two cliff sensors may be installed on a relatively rear side.

For example, the cliff sensor may be a PSD sensor or may include a plurality of different kinds of sensor.

The PSD sensor detects the positions of the short and long distances of an incident light with a single p-n junction by using the surface resistance of a semiconductor. The PSD sensor includes a 1D PSD sensor that detects light on a single axis and a 2D PSD sensor that may detect the position of light on the surface, and they have a pin photodiode structure. The PSD sensor is a type of infrared sensor which transmits an infrared ray to an obstacle and measures an angle between the infrared ray transmitted to the obstacle an infrared ray returned after being reflected from the obstacle, thus measuring a distance therebetween. That is, the PSD sensor calculates a distance to the obstacle using triangulation.

The PSD sensor includes a light emitting unit emitting infrared light to an obstacle and a light receiving unit receiving infrared light returned after being reflected from the obstacle. In general, the PSD sensor is formed as a module. In case where an obstacle is sensed by using the PSD sensor, a stable measurement value may be obtained regardless of difference in reflectivity or color of the obstacle.

The controller 180 may measure an angle between an infrared light emitting signal irradiated by the cliff sensor toward the floor and a reflection signal received after being reflected from the obstacle to sense a cliff, and analyze a depth thereof.

Meanwhile, the controller 180 may determine whether the moving robot may be able to pass through a cliff according to a floor state of the cliff sensed by using the cliff sensor. For example, the controller 180 may determine whether a cliff is present and a depth of the cliff through the cliff sensor and only when a reflection signal is sensed by the cliff sensor, the controller 180 allows the moving robot to pass through the cliff.

In another example, the controller 180 may determine whether the moving robot is lifted using the cliff sensor.

Also, referring to FIG. 1B, the sensor 140 may include at least one of a gyro sensor 141, an acceleration sensor 142, a wheel sensor 143, and a camera sensor 144.

When the moving robot moves, the gyro sensor 141 senses a rotation direction and detects a rotation angle. Specifically, the gyro sensor 141 may detect an angular velocity of the robot cleaner and output a voltage or current value proportional to the angular velocity, and the controller 180 may detect the rotation angle and the rotation angle of the robot cleaner using the voltage or current value output from the gyro sensor.

The acceleration sensor 142 senses a change in a speed of the robot cleaner. For example, the acceleration sensor 142 may sense a change in a moving speed due to start, stop, change of direction, or collision with an object, for example. The acceleration sensor 142 may be attached to a position adjacent to the main wheel or the auxiliary wheel to detect a slip or idle rotation of the wheel. In addition, the acceleration sensor 142 may be built in an motion sensing unit and may detect a change in the speed the robot cleaner. That is, the acceleration sensor 142 detects the amount of impact according to a change in speed and outputs a corresponding voltage or current value. Thus, the acceleration sensor may perform the function of an electronic bumper.

The wheel sensor 143 is connected to the main wheel to sense the number of rotations of the main wheel. Here, the wheel sensor 143 may be an encoder. The encoder senses and outputs the number of rotations of the left and/or right main wheels. The motion sensing unit may calculate a rotation speed of the left and right wheels using the number of rotations and calculate a rotation angle of the robot cleaner using a difference in the number of rotations between the left and right wheels.

Meanwhile, the camera sensor 144 may be provided on a rear surface of the moving robot and obtain image information related to the lower side, i.e., the floor (or a cleaning target surface) during movement. The camera sensor provided on the rear surface of the moving robot may be defined as a lower camera sensor and may also be referred to as an optical flow sensor.

The lower camera sensor may convert an image of the lower side input from an image sensor provided therein to generate a predetermined format of image data. The generated image data may be stored in the memory 170.

The lower camera sensor may further include a lens (not shown) and a lens adjusting unit (not shown) for adjusting the lens. It is preferable to use a pan-focus type lens having a short focal length and a deep depth as the lens. The lens adjusting unit includes a predetermined motor and a moving unit for moving the lens back and forth to adjust the lens.

Also, one or more light sources may be installed to be adjacent to the image sensor. One or more light sources irradiate light to a predetermined region of the floor captured by the image sensor. Namely, in case where the moving robot moves a cleaning region along the floor, when the floor is smooth, a predetermined distance is maintained between the image sensor and the floor. On the other hand, in case where the moving robot moves on the floor which is uneven, the image sensor may become away from the floor by a predetermined distance or greater due to depressions and protrusions and an obstacle of the floor. In this case, the one or more light sources may be controlled by the controller 180 such that an amount of irradiated light may be adjusted. The light sources may be a light emitting device, for example, a light emitting diode (LED), or the like, whose amount of light may be adjusted.

The controller 180 may detect a position of the moving robot regardless of whether the moving robot slides by using the lower camera sensor. The controller 180 may compare and analyze image data captured by the lower camera sensor over time to calculate a movement distance and a movement direction, and calculate a position of the moving robot on the basis of the calculated movement distance and the calculated movement direction. By using the image information regarding the lower side of the moving robot using the lower camera sensor, the controller 180 may perform correction resistant to sliding with respect to a position of the moving robot calculated by other means.

Meanwhile, the camera sensor may be installed to face an upper side or a front side of the moving robot to image surroundings of the moving robot. The camera sensor installed to face the upper side or the front side of the moving robot may be defined as an upper camera sensor. When the moving robot includes a plurality of upper camera sensors, the camera sensors may be formed on the upper portion or side surface of the moving robot at a certain distance or at a certain angle.

The upper camera sensor may include a lens for adjusting a focal point of a subject, an adjusting unit for adjusting the camera sensor, and a lens adjusting unit for adjusting the lens. As the lens, a lens having a wide angle of view may be used such that every surrounding region, for example, the entire region of the ceiling, may be imaged even in a predetermined position. For example, a lens having an angle equal to or greater than a predetermined angle of view, for example, equal to or greater than 160 degrees, may be used.

The controller 180 may recognize a position of the moving robot using image data captured by the upper camera sensor, and create map information regarding a specific region. The controller 180 may precisely recognize a position by using image data obtained by the acceleration sensor, the gyro sensor, the wheel sensor, and the lower camera sensor and the image data obtained by the upper camera sensor.

Also, the controller 180 may generate map information by using the obstacle information detected by the front sensor, the obstacle sensor, and the like, and the position recognized by the upper camera sensor. Alternatively, the map information may be received from the outside and stored in the storage unit 170, rather than being created by the controller 180.

In an embodiment, the upper camera sensor may be installed to face a front side of the moving robot. Also, an installation direction of the upper camera sensor may be fixed or may be changed by the controller 180.

The cleaning unit 190 includes an agitator rotatably installed in a lower portion of a main body of the moving robot, and a side brush rotating about a rotational shaft of the main body of the moving robot in a vertical direction to clean the corner, a nook, and the like, of a cleaning region such as a wall surface, or the like.

The agitator rotates about an axis of the main body of the moving robot in a horizontal direction, to make dust of the floor, the carpet, and the like, float in the air. A plurality of blades are provided in a spiral direction on an outer circumferential surface of the agitator. A brush may be provided between the spiral blades. Since the agitator and the side brush rotate about different axes, the moving robot generally needs to have a motor for driving the agitator and a motor for driving the side brush.

The side brush is disposed on both sides of the agitator and a motor unit is provided between the agitator and the side brush to transmit rotary power of the agitator to the side brush, such that both the agitator and the side brush may be driven by using a single brush motor. In this case, as the motor unit, a worm and a worm gear may be used, or a belt may be used.

The cleaning unit 190 may include a dust bin storing collected dust, a sucking fan providing power to suck dust in a cleaning region, and a sucking motor rotating the sucking fan to suck air, thereby sucking dust or foreign objects.

The sucking fan includes a plurality of blades for making air flow, and a member formed to have an annular shape on an outer edge of an upper stream of the plurality of blades to connect the plurality of blades, and guiding air introduced in a direction of a central axis of the sucking fan to flow in a direction perpendicular to the central axis.

Here, the cleaning unit 190 may further include a filter having a substantially rectangular shape and filtering out filth or dust in the air.

The filter may include a first filter and a second filter as needed, and a bypass filter may be formed in a body forming the filter. The first filter and the second filter may be a mesh filter or a high efficiency particulate arresting (HEPA) filter. The first filter and the second filter may be formed of either non-woven cloth or a paper filter, or both the non-woven cloth and the paper filter may be used together.

The controller 180 may detect a state of the dust bin. In detail, the controller 180 may detect an amount of dust collected in the dust bin and detect whether the dust bin is installed in the moving robot or whether the dust bin has been separated from the moving robot. In this case, the controller may sense a degree to which dust is collected in the dust bin by inserting a piezoelectric sensor, or the like, into the dust bin. Also, an installation state of the dust bin may be sensed in various manners. For example, as a sensor for sensing whether the dust bin is installed, a microswitch installed to be turned on and off on a lower surface of a recess in which the dust bin is installed, a magnetic sensor using a magnetic field of a magnet, an optical sensor including a light emitting unit and a light receiving unit, and receiving light, and the like, may be used. The magnetic sensor may include a sealing member formed of a synthetic rubber material in portion where magnet is bonded.

Also, the cleaning unit 190 may further include a rag plate detachably attached to a lower portion of the main body of the moving robot. The rag plate may include a detachably attached rag, and the user may separate the rag to wash or replace it. The rag may be installed in the rag plate in various manners, and may be attached to the rag plate by using a patch called Velcro. For example, the rag plate is installed in the main body of the moving robot by magnetism. The rag plate includes a first magnet and the main body of the cleaner may include a metal member or a second magnet corresponding to the first magnet. When the rag plate is normally positioned on the bottom of the main body of the moving robot, the rag plate is fixed to the main body of the moving robot by the first magnet and a metal member or the first magnet and the second magnet.

The moving robot may further include a sensor for sensing whether the rag plate is installed. For example, the sensor may be a reed switch operated by magnetism, or may be a hall sensor. For example, the reed switch may be provided in the main body of the moving robot, and when the rag plate is coupled to the main body of the moving robot, the reed switch may operate to output an installation signal to the controller 180.

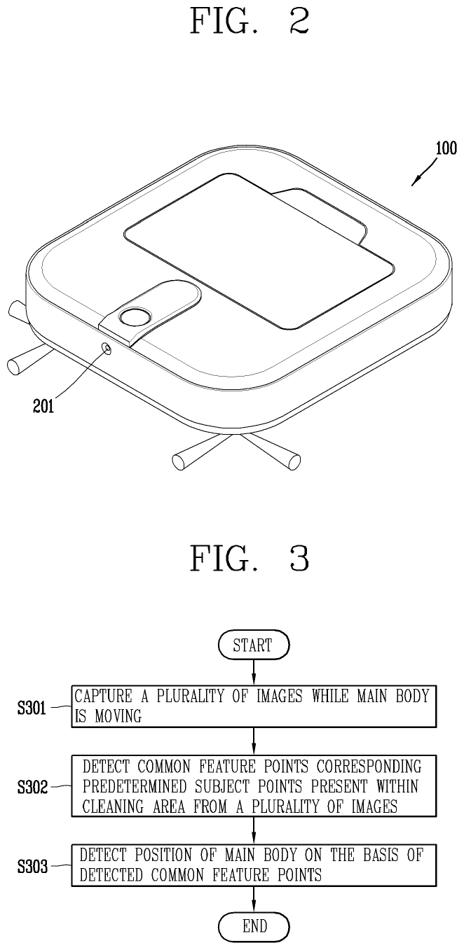

Hereinafter, an embodiment related to an appearance of the moving robot according to an embodiment of the present disclosure will be described with reference to FIG. 2.

Referring to FIG. 2, the moving robot 100 may include a single camera 201. The single camera 201 may correspond to the camera sensor 144. Also, an image capture angle of the camera sensor 144 may be an omnidirectional range.

Meanwhile, although not shown in FIG. 2, the moving robot 100 may include a lighting unit together with the camera sensor 144. The lighting unit may irradiate light in a direction in which the camera sensor 144 is oriented.

In addition, hereinafter, the moving robot 100 and “a cleaner performing autonomous traveling” are defined as having the same concept.

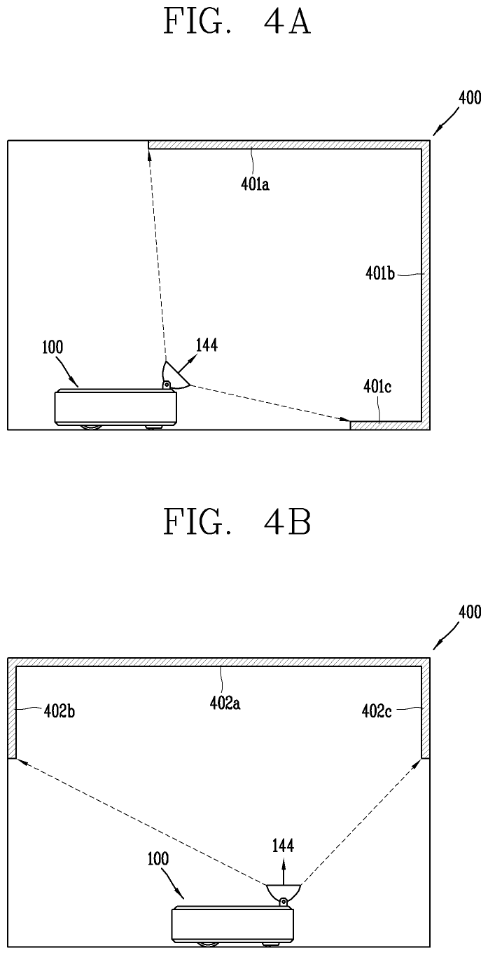

Hereinafter, a method of controlling the moving robot 100 according to an embodiment of the present disclosure will be described with reference to FIG. 3.

The camera sensor 144 may capture a plurality of images, while the main body is moving (S301).

As illustrated in FIG. 2, the camera sensor 144 according to an embodiment of the present invention may be a monocular camera fixedly installed in the main body of the moving robot 100. That is, the camera sensor 144 may capture the plurality of images in a direction fixed with respect to a movement direction of the main body.

When a preset time interval has lapsed since a first image is captured, the camera sensor 144 according to another embodiment of the present invention may capture a second image.

Specifically, after the first image is captured, when the main body moves by a predetermined distance or when the main body rotates by a predetermined angle, the camera sensor 144 may capture the second image.

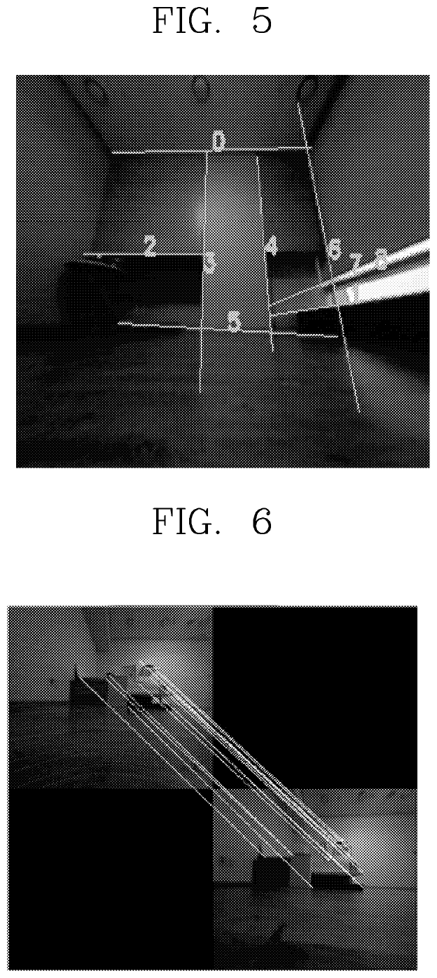

A more detailed description related to an angle of coverage of the camera sensor 144 will be described hereinafter with reference to FIGS. 4A and 4B.

The controller 180 may detect common feature points corresponding to predetermined subject points present in a cleaning area from a plurality of captured images (S302).

In addition, the controller 180 may detect information related to a position of the main body based on the detected common feature points (S303).

Specifically, the controller 180 may calculate a distance between the subject points and the main body based on the detected common feature points.

The controller 180 may correct information related to the detected position of the main body based on the information detected by the operation sensor while a plurality of images are being captured.

When the camera captures the ceiling of the cleaning area, the controller 180 may detect feature points corresponding to the corner of the ceiling from the plurality of images.

Referring to FIG. 4A, a direction of an axis of the camera sensor 144 may form a predetermined angle with the floor of the cleaning area.

The angle of coverage of the camera sensor 144 may cover a portion of a ceiling 401a, a wall 401b and a floor 401c of the cleaning area 400. That is, the direction in which the camera sensor 144 is oriented may form a predetermined angle with the floor such that the camera sensor 144 may image the ceiling 401a, the wall 401b, and the floor 401c of the cleaning area 400 together.

Referring to FIG. 4B, an axis of the camera sensor 144 may be oriented to the ceiling of the cleaning area.

In detail, an angle of coverage of the camera sensor 144 may cover a portion of the ceiling 402a, the first wall 402b, and the second wall 402c of the cleaning area 400.

Meanwhile, although not shown in FIG. 4B, a viewing angle of the camera sensor 144 may cover portions of a third wall (not shown) and a fourth wall (not shown). That is, when the axis of the camera sensor 144 is directed to the ceiling of the cleaning area, the angle of coverage of the camera sensor 144 may cover an area located in all directions with respect to the main body.

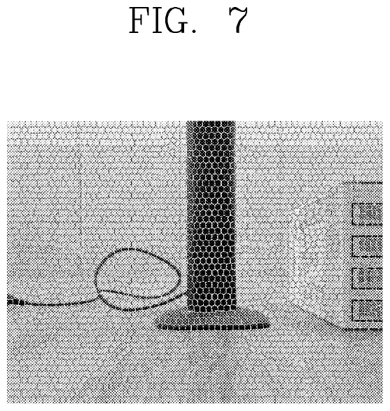

As illustrated in FIG. 5, the controller 180 may extract at least one feature line from a plurality of captured images. The controller 180 may detect information related to a position of the main body or correct information related to the position of the main body which has already been set, using the extracted feature lines.

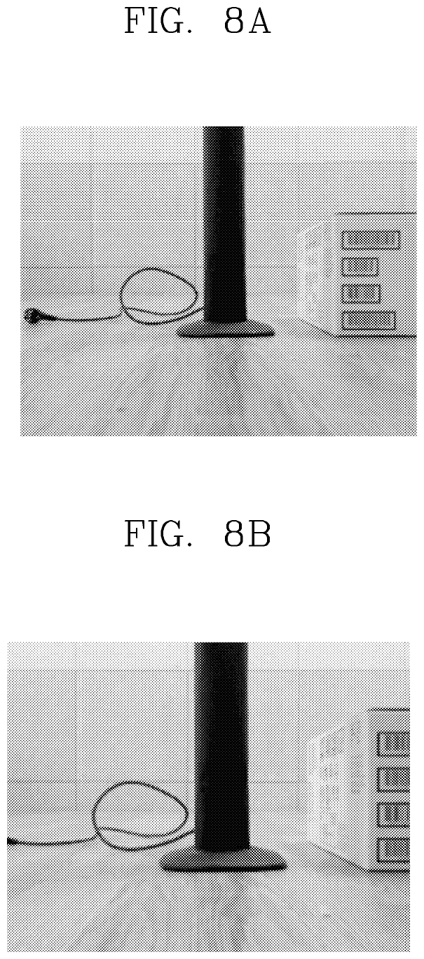

Referring to FIG. 6, the controller 180 may detect common subject points corresponding to predetermined subject points present in the cleaning area from the plurality of captured images. The controller 180 may detect information related to the position of the main body or correct the information related to the position of the main body which has already been set, based on the detected common subject points.

Here, the plurality of captured images may include an image related to a wall positioned in front of the main body, a ceiling located above the main body, and a floor positioned below the main body.

That is, the controller 180 may extract feature points corresponding to the walls, the ceiling, and the floor from each image, and match the extracted feature points for each image.

In addition, the robot cleaner 100 according to the present invention may include an illumination sensor (not shown) to detect the amount of light applied to one point of the main body, and the controller 180 may adjust an output of a lighting unit based on an output from the lighting unit.

As illustrated in FIGS. 5 and 6, when the robot cleaner 100 is located in a dark environment, the controller 180 may increase output of the lighting unit, whereby an image allowing extraction of feature lines and feature points may be captured.

Meanwhile, the operation sensor 141, 142, or 143 may sense movement of the moving robot or information related to movement of the main body of the moving robot.

The operation sensor may include at least one of the gyro sensor 141, the acceleration sensor 142, and the wheel sensor 143.

The controller 180 may detect information related to an obstacle on the basis of at least one of the first captured image and information related to the sensed movement.

In detail, the controller 180 may detect the information related to the obstacle by extracting feature points regarding the first image, segmenting the first image, or projecting the first image to a different image. In this manner, in order to detect information related to the obstacle from the first image, the controller 180 may make various analyses and finally detect information related to the obstacle by applying different weight values to the analysis results.

The controller 180 may control the driving unit 130 on the basis of the detected information related to the obstacle.

In detail, the controller 180 may generate map information related to the obstacle by using the detected information related to the obstacle or update previously stored map information. In addition, the controller 180 may control the driving unit 130 to avoid collision of the moving robot 100 with respect to the obstacle on the basis of the map information. In this case, the controller 180 may use a preset avoidance operation algorithm or may control the driving unit 130 to maintain a distance between the obstacle and the moving robot 100 at a predetermined interval or greater.

Hereinafter, various embodiments in which the moving robot 100 or the cleaner performing autonomous traveling detect information related to an obstacle from an image captured by the camera sensor 144 will be described.

In an embodiment, the controller 180 may detect first information related to an obstacle by segmenting an image captured by the camera sensor 144.

The controller 180 may segment the captured first image into a plurality of image regions. In addition, the controller 180 may detect first information related to an obstacle from the segmented image regions. For example, the controller 180 may set information related to a plurality of image regions included in the first image by using a super-pixel algorithm with respect to the first image.

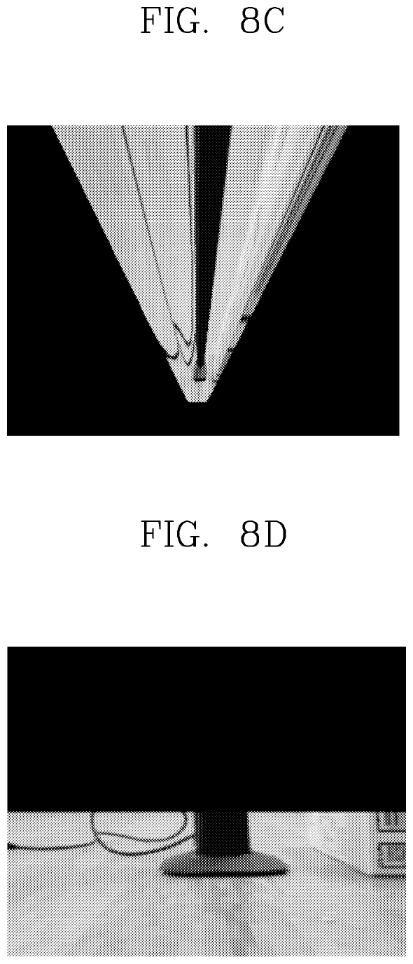

FIG. 7 illustrates an embodiment in which information related to a plurality of image regions is set by segmenting the first image.

Also, when a preset time interval has lapsed since the first image was captured, the camera sensor 144 may capture a second image. That is, the camera sensor 144 may capture the first image at a first time point and capture a second image at a second time point after the first time point.

The controller 180 may segment the second image into a plurality of image regions.

In addition, the controller 180 may compare the segmented image regions of the first image and the segmented image regions of the second image. The controller 180 may detect the first information related to an obstacle on the basis of the comparison result.

The controller 180 may match corresponding regions of the segmented image regions of the second image to the segmented image regions of the first image. That is, the controller 180 may compare the plurality of image regions included in the first image captured at the first time point and the plurality of image regions included in the second image captured at the second time point, and match the plurality of image regions included in the second image to corresponding regions of the plurality of image regions included in the first image.

Accordingly, the controller 180 may detect the first information related to an obstacle on the basis of the matching result.

Meanwhile, when traveling of the moving robot 100 performed after the first point in time at which the first image was captured satisfies specific conditions, the camera sensor 144 may capture the second image. For example, the specific conditions may include conditions related to at least one of a traveling time, a traveling distance, and a traveling direction.

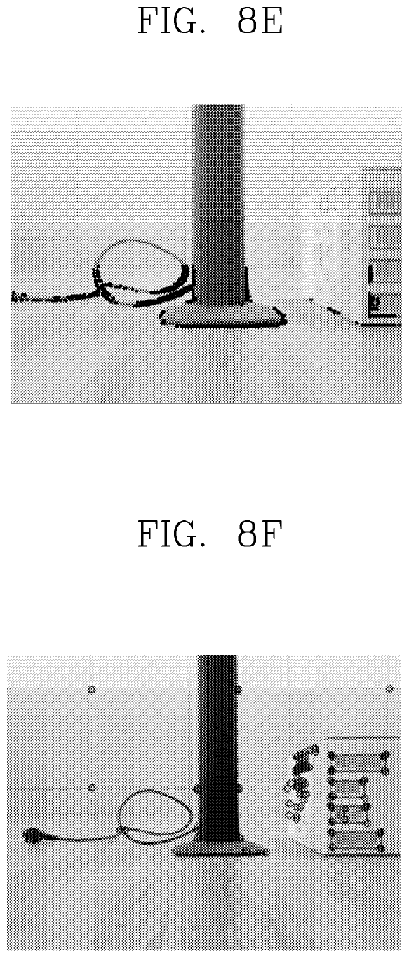

Hereinafter, an embodiment in which the moving robot according to the present disclosure detects an obstacle using a plurality of captured images will be described with reference to FIGS. 8A to 8E.

FIG. 8A illustrates a first image, and FIG. 8B illustrates a second image. As discussed above, the first image may be captured by the camera sensor 144 at the first time point and the second image may be captured by the camera sensor 144 at the second time point.

The controller 180 may convert the first image on the basis of information related to a floor in contact with the driving unit 130 of the moving robot 100. In this case, the information related to the floor may be set in advance by the user. Referring to FIG. 8C, the converted first image is illustrated. That is, the controller 180 may convert the first image by performing inverse perspective mapping on the first image.

For example, the controller 180 may project the first image with respect to a reference image related to the floor corresponding to the first image. In this case, the controller 180 may convert the first image on the assumption that there is no obstacle on the floor corresponding to the first image.

In addition, the controller 180 may generate a third image by projecting the converted image to the second image.

In detail, the controller 180 may back-project the converted first image to the second image. Referring to FIG. 8D, the converted first image may be back-projected to the second image to generate the third image.

Also, the controller 180 may detect second information related to an obstacle by comparing the generated third image with the second image. The controller 180 may detect the second information related to an obstacle on the basis of a difference in color between the generated third image and the second image.

FIG. 8E illustrates an embodiment in which the detected second information is displayed on the second image. In FIG. 5E, the black points mark the detected second information.

The inverse perspective mapping algorithm mentioned above may also be performed on a segmented I mage region of a captured image. That is, as mentioned above, the controller 180 may perform the inverse perspective mapping algorithm on the plurality of matched image regions among the plurality of image regions included in the first and second images. That is, the controller 180 may perform the inverse perspective mapping algorithm on one of the plurality of image regions included in the first image and the image region which is matched to the one image region included in the first image and which is included in the second image to detect information related to an obstacle.

In another embodiment, the controller 180 may extract at least one feature point with respect to the first and second images. In addition, the controller 180 may detect third information related to the obstacle on the basis of the extracted feature point.

In detail, the controller 180 may estimate information related to an optical flow of the first and second images which are continuously captured. On the basis of the estimated optical flow, the controller 180 may extract information related to homography regarding the floor on which the moving robot 100 is traveling. Accordingly, the controller 180 may detect the third information related to the obstacle by using the information related to the homography. For example, the controller 180 may detect the third information related to the obstacle by calculating an error value of the homography corresponding to extracted feature points.

In another example, the controller 180 may extract a feature point on the basis of a corner or a segment included in the first and second images.

FIG. 8F illustrates an embodiment in which a feature point extraction is performed on the first image. The black points illustrated in FIG. 8F indicate the detected third information.

Meanwhile, the controller 180 may set information related to a weight value with respect to each of the first to third information. In addition, the controller 180 may detect fourth information related to the obstacle on the basis of the set weight values and the first to third information.

In detail, the controller 180 may set information related to the weight values respectively corresponding to the first to third information by using a graph-cut algorithm. Also, the controller 180 may set information related to the weight values on the basis of a user input. Accordingly, the controller 180 may finally detect fourth information related to the obstacle by combining the obstacle detection methods described above.

Also, the controller 180 may generate map information related to the obstacle by using the first to fourth information.

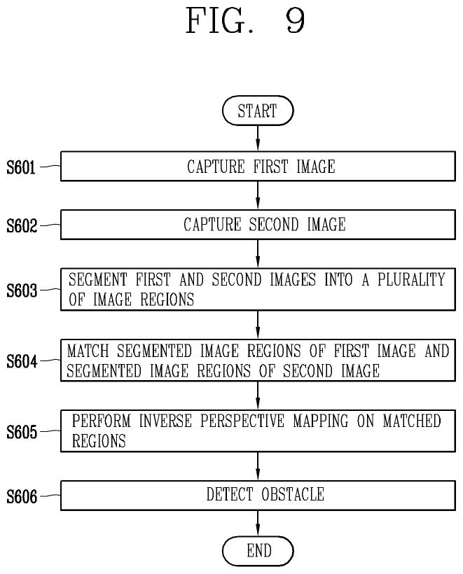

Hereinafter, another embodiment related to a control method of a moving robot of the present disclosure will be described with reference to FIG. 9.

The camera sensor 144 may capture a first image (S601), and capture a second image after the first image is captured (S602).

The controller 180 may segments each of the first and second images into a plurality of regions (S603).

The controller 180 may match the segmented image regions of the second image and the segmented images of the first image (S604).

The controller 180 may inverse-perspective-map any one of the matched regions to the other region (S605).

The controller 180 may detect an obstacle on the basis of the result of the inverse perspective mapping (S606).

According to embodiments of the present disclosure, since an obstacle may be detected only through a single camera, manufacturing cost of the moving robot may be reduced.

In addition, the moving robot according to the present disclosure may have enhanced performance in detecting an obstacle by using a monocular camera.

Also, the moving robot according to the present disclosure may accurately detect an obstacle, regardless of an installation state of the camera.

The foregoing embodiments and advantages are merely exemplary and are not to be considered as limiting the present disclosure. The present teachings may be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

1. A cleaner comprising:
a main body having a suction opening;
a cleaning unit provided within the main body and sucking a cleaning target through the suction opening;
a driving unit moving the main body;
an operation sensor detecting information related to movement of the main body;
a camera capturing a plurality of images according to movement of the main body; and
a controller detecting information related to a position of the main body on the basis of at least one of the captured images and information related to the movement.

2. The cleaner of claim 1, wherein the controller detects feature points corresponding to predetermined subject points present in a cleaning area with respect to the plurality of captured images, and detects information related to the position of the main body on the basis of the detected common feature points.

3. The cleaner of claim 2, wherein the controller calculates a distance between the subject points and the main body on the basis of the detected common feature points.

4. The cleaner of claim 2, wherein while the plurality of images are being captured, the controller corrects the detected information related to the position of the main body on the basis of the information detected by the operation sensor, while the plurality of images are being captured.

5. The cleaner of claim 2, wherein when the camera images a ceiling of the cleaning area, the controller detects feature points corresponding to a corner of the ceiling from the plurality of images.

6. The cleaner of claim 1, wherein when a preset time interval has lapsed since the first image was captured, the camera captures a second image.

7. The cleaner of claim 1, wherein after the first image is captured, when the main body moves by a predetermined distance or rotates by a predetermined angle, the camera captures the second image.

8. The cleaner of claim 1, wherein the camera is installed at one point of the main body such that a direction in which a lens of the camera is oriented is fixed.

9. The cleaner of claim 1, wherein an angle of coverage of the camera corresponds to all directions with respect to the main body.

10. The cleaner of claim 1, wherein the controller newly generates a third image by projecting the first image among the plurality of images to the second image among the plurality of images, and detects information related to an obstacle on the basis of the generated third image.
